(19) United States
(12) Patent Application Publication
(10) Pub. No.: US 2019/0381985 A1
(43) Pub. Date: Dec. 19, 2019

(54) Control Valve Conversion System

(71) Applicant: Westinghouse Air Brake Technologies Corporation, Wilmerding, PA (US)

(72) Inventors: Larren A. Burress, Monroeville, PA (US); Edward W. Gaughan, Greensburg, PA (US)

(21) Appl. No.: 16/558,221

(22) Filed: Sep. 2, 2019

Related U.S. Application Data
(63) Continuation-in-part of application No. 14/402,318, filed on Nov. 20, 2014, now Pat. No. 10,435,004.
(60) Provisional application No. 61/653,791, filed on May 31, 2012.

(51) Int. Cl. B60T 15/02

(52) U.S. Cl. CPC B60T 15/021; F16K 3/0272

(57) ABSTRACT

A system for converting an ABDW-type control valve to an ABDX-type control valve for use in a braking mechanism for a railway vehicle includes an ABDW-type control valve body in communication with an air supply system of the braking mechanism for controlling an application and release of brakes in response to changes in air pressure within the braking mechanism. A breather plate is mounted on an accelerated application valve interface on the control valve body. The breather plate has an internal stability volume for compensating a function of an accelerated application valve. A modified slide valve bushing is mounted inside the control valve body for establishing fluid communication with at least one passageway within the control valve body. At least one plug mounted is to at least one air passageway within the control valve body for sealing or choking the at least one air passageway.

### CROSS-REFERENCE TO RELATED APPLICATIONS

This application is a continuation-in-part of U.S. patent application Ser. No. 14/402,318, filed on 29 May 2013. U.S. patent application Ser. No. 14/402,318 is a national stage national stage application, filed under 35 U.S.C. § 371, of International Patent Application No. PCT/US13/42990, filed on 29 May 2013. International Patent Application No. PCT/US13/42990 claims priority to U.S. Provisional Application No. 61/653,791, filed on 31 May 2012. The entire disclosures of each of these applications are incorporated herein by reference.

### BACKGROUND

### Technical Field

The present disclosure relates generally to control valves.

### Description of Related Art

Railway vehicle braking systems generally operate by charging and discharging compressed air to and from one or more storage reservoirs located on each railway car. Each storage reservoir is connected to a compressed air source, such as a locomotive air compressor, by a brake pipe. The storage reservoirs are typically separated from the brake pipe by a brake valve which is sensitive to changes in air pressure in the brake pipe. The brake valve senses a pressure drop in the brake pipe and utilizes the compressed air from one or more storage reservoirs to apply the brakes. Because brakes are applied by discharging the air pressure from the storage reservoirs, modern railway vehicle braking systems have a built-in safety feature. In case of a significant air loss, such as during unwanted separation of railway vehicles or a sudden failure of the compressed air source, the brake valve will initiate a full-force, emergency brake application by discharging the compressed air stored in the storage reservoirs.

Railway vehicle braking systems are typically controlled by an operator using a control stand in the locomotive. As the brake valve is moved to release the compressed air in the brake pipe, the loss in air pressure is sensed by individual brake valves on each railway vehicle. Using the air pressure from the one or more storage reservoirs on the railway vehicle, the brake valve applies force on a brake piston to apply the brakes on the railway vehicle. To release the brakes, the air pressure in the brake pipe is restored to cause the brake valve to exhaust the pressure in the brake piston and thereby release the brakes. The system then recharges the air in the storage reservoirs and maintains the air pressure in the brake pipe until the subsequent brake application.

Over the years, a number of railway vehicle braking systems have evolved, the AB-based braking system being the most common. In the AB-based braking system, slight brake pipe pressure reductions do not cause unintended service or emergency brake applications and there is less sensitivity to brake pipe leakage compared to previous braking systems. AB-based control valves receive air from the brake pipe through a cross-over pipe and direct the air to various reservoirs on the railway vehicle during the recharging of the braking system. A plurality of different AB-based control valves has been developed throughout the years.

In one embodiment, an ABD-type control valve includes a pipe bracket and two primary operating portions. Pipe connections from the brake pipe are made to the valve body, which is secured to the frame of a railway vehicle. The two primary operating portions include an emergency portion and a service operating portion. ABD-type control valves include an accelerated release function, where a rapid rise in brake pipe pressure on a first railway vehicle causes a chain reaction on the rest of the vehicles throughout the train and a much quicker release of the brakes.

An improvement to the ABD-type control valve was introduced in 1974 in the form of an ABDW control valve. The ABDW control valve provides for faster brake application and continuous action though an accelerated application valve. The ABDW control valve exhausts air from the brake pipe locally at each car using the accelerated application valve as long as air is being exhausted at the automatic brake valve in the control stand of the locomotive. This causes an accelerated buildup of brake cylinder pressure during service brake applications. During a brake release, the ABDW valve functions in a similar manner to an ABD valve. These control valves are approved for railway vehicles of up to 75 feet in length. Railway vehicles equipped with an ABDW control valve that exceed the 75-foot length must be equipped with additional or supplemental devices to provide an increase in accelerated application valve activity.

The latest improvement to AB-type control valves occurred in 1994 with the introduction of an ABDX control valve. The ABDX control valves are designed for operation on conventional trains and modern freight trains that are longer, heavier, and operate at higher speeds. Whereas ABDW control valves rely on an external accelerated application valve to cause a local exhaustion of air from the brake pipe, ABDX valves have a built-in capability that eliminates the need for an external accelerated application valve. The ABDX control valves provide an improved, more efficient accelerated application valve function, as well as increased stability against undesired emergency applications resulting from fluctuations in brake pipe pressure.

Considering that a plurality of AB-type control valves has been developed throughout the years, railway vehicles traveling on today's railways may be equipped with any of the above-described control valves. While most new railway vehicles are built with the most modern ABDX-type control valves, many existing railway vehicles utilize older, less-effective AB-type control valves, such as an ABDW-type valve. To update the braking system of an older railway car to the newest control valve, it may be necessary to completely replace an existing ABDW control valve with a new ABDX control valve. The upgrade from an ABDW-type control valve to an ABDX-type control valve provides an improved accelerated application valve and the stability functionality of the ABDX-type control valve.

### BRIEF SUMMARY

In view of the foregoing, a need exists in the art to convert an existing ABDW-type control valve to have the function of an ABDX-type control valve without replacing the existing control valve. An additional need exists for an apparatus and method for converting the ABDW-type control valve to have the service stability, application speed, and other operating parameters of an ABDX-type control valve.

Accordingly, a system for converting an ABDW-type control valve to an ABDX-type control valve for use in a braking mechanism for a railway vehicle is needed. In accordance with one embodiment, the system may include an ABDW-type control valve body in communication with an air supply system of the braking mechanism for the railway vehicle. The control valve body is desirably operative for controlling an application and release of brakes in response to changes in air pressure within the braking mechanism for the railway vehicle. The system may further include a breather plate provided on an accelerated application valve interface on the control valve body. The breather plate may have an internal stability volume for compensating a function of an accelerated application valve. A slide valve bushing may be provided inside the control valve body for establishing fluid communication with at least one passageway within the control valve body. Additionally, at least one plug may be provided for sealing at least one air passageway within the control valve body.

In accordance with another embodiment, the breather plate may further include a body having a first side opposite a second side and an internal stability volume between the first side and the second side. The breather plate may additionally include a first opening and a second opening in communication with the internal stability volume and in alignment with a first passageway and a second passageway on the accelerated application valve interface of the control valve body. A gasket surrounding the first opening and the second opening may be provided for sealing the fluid connection between the first passageway on the control valve body and the first opening on the breather plate and the second passageway on the control valve body and the second opening on the breather plate. A plurality of through holes in alignment with a plurality of bolt holes on the accelerated application valve interface of the ABDW-type control valve body may be provided for connecting the breather plate to the control valve body.

In accordance with yet another embodiment, the breather plate may further include a breather plate plug connected to the body and in communication with the internal stability volume. In one embodiment, the breather plate plug may extend within the internal stability volume. Additionally, the breather plate plug may include an O-ring seal. In another embodiment, the breather plate may further include a recessed gasket face on the first side of the breather plate. The gasket may be recessed within the recessed gasket face. A choke plug may be provided in one of the first opening or the second opening. The choke plug may have a central passage extending through a longitudinal length thereof. The breather plate may further include a drive stud provided on the first side for engaging a corresponding opening provided on the control valve body.

In a further embodiment, the slide valve bushing may include a plurality of recessed passageways extending around at least a part of an external perimeter of the bushing. The plurality of recessed passageways is desirably separated axially along a longitudinal extent of the bushing. Additionally, the slide valve bushing may include a plurality of through passages extending radially through at least one side of the bushing, wherein the plurality of through passages may be separated axially along a longitudinal extent of the bushing. In one embodiment, one of the plurality of plugs may be an accelerated application valve choke plug provided in an accelerated application valve choke on the valve body. The accelerated application valve choke plug may include a mesh filter to filter impurities in air passing through the accelerated application valve choke. In another embodiment, the accelerated application valve choke plug may be inserted into an accelerated application valve bushing that is pressed inside the accelerated application valve opening. In a further embodiment, a slot may be provided between accelerated application valve opening and an air chamber to establish a fluid connection between the accelerated application valve opening and the air chamber.

In another embodiment, a breather plate for connecting and mounting to an accelerated application valve interface of an ABDW-type control valve body for converting an ABDW-type control valve to an ABDX-type control valve may include a body having a first side opposite a second side and an internal stability volume between the first side and the second side.

The breather plate may additionally include a first opening and a second opening in communication with the internal stability volume and in alignment with a first passageway and a second passageway on the accelerated application valve interface of the control valve body. A gasket surrounding the first opening and the second opening may be provided for sealing the fluid connection between the first passageway on the control valve body and the first opening on the breather plate and the second passageway on the control valve body and the second opening on the breather plate. A plurality of through holes in alignment with a plurality of bolt holes on the accelerated application valve interface of the ABDW-type control valve body may be provided for connecting the breather plate to the control valve body.

In accordance with yet another embodiment, the breather plate may further include a breather plate plug connected to the body and in communication with the internal stability volume. In one embodiment, the breather plate plug may be set within the internal stability volume. Additionally, the breather plate plug may include an O-ring seal. In another embodiment, the breather plate may further include a recessed gasket face on the first side of the breather plate. The gasket may be recessed within the recessed gasket face. A choke plug may be provided in one of the first opening or the second opening. The choke plug may have a central passage extending through a longitudinal length thereof. The breather plate may further include a drive stud provided on the first side for engaging a corresponding opening provided on the control valve body.

In yet another embodiment, a method for converting an ABDW-type control valve to an ABDX-type control valve for use in a braking mechanism for a railway vehicle may include the steps of removing an accelerated application valve from an ABDW-type control valve body to expose an accelerated application valve interface and mounting a breather plate on the accelerated application valve interface. The breather plate may have an internal stability volume for compensating the function of the accelerated application valve. The method may further include the steps of mounting a slide valve bushing inside the control valve body for establishing fluid communication with at least one passageway within the control valve body. In another embodiment, the method may include the step of mounting at least one plug for sealing at least one air passageway within the control valve body. In a further embodiment, the method may include the steps of expanding an accelerated application valve opening for pressing an accelerated valve bushing and providing a slot between the accelerated application valve opening and an air chamber on the valve body for establishing a fluid communication between the accelerated application valve opening and the air chamber.

These and other features and characteristics of the apparatus and method for ABDW to ABDX control valve conversion, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the inventive subject matter. As used in the specification and the claims, the singular form of “a”, “an”, and “the” include plural referents unless the context clearly dictates otherwise.

### BRIEF DESCRIPTION OF THE DRAWINGS

FIG. 1A is a front view of an ABDW control valve body modified in accordance with one embodiment of the present disclosure;

FIG. 1B is rear view of the ABDW control valve body shown in FIG. 1A;

FIG. 1C is a left side view of the ABDW control valve body shown in FIG. 1A;

FIG. 1D is a right side view of the ABDW control valve body shown in FIG. 1A;

FIG. 1E is a top view of the ABDW control valve body shown in FIG. 1A;

FIG. 2 is a perspective view of an ABDW control valve modified in accordance with one embodiment of the present disclosure;

FIG. 3A is a perspective view of an assembled breather plate for use on an emergency portion of an ABDW control valve modified in accordance with one embodiment of the present disclosure;

FIG. 3B is an exploded perspective view of the breather plate shown in FIG. 3A;

FIG. 3C is a front view of the breather plate shown in FIG. 3A;

FIG. 3D is a cross-sectional view of the breather plate shown in FIG. 3C, taken along the line A1-A1;

FIG. 3E is a cross-sectional view of the breather plate shown in FIG. 3C, taken along the line B1-B1;

FIG. 4A is a right side view of a slide valve bushing for use with an ABDW control valve modified in accordance with one embodiment of the present disclosure;

FIG. 4B is a bottom view of the slide valve bushing shown in FIG. 4A;

FIG. 4C is a front view of the slide valve bushing shown in FIG. 4A;

FIG. 4D is a side cross-sectional view of the slide valve bushing shown in FIG. 4C, taken along the line A1-A1;

FIG. 4E is a front cross-sectional view of the slide valve bushing shown in FIG. 4D, taken along the line C-C;

FIG. 4F is a front cross-sectional view of the slide valve bushing shown in FIG. 4D, taken along the line D-D;

FIG. 4G is a front cross-sectional view of the slide valve bushing shown in FIG. 4D, taken along the line E-E;

FIG. 4H is a front cross-sectional view of the slide valve bushing shown in FIG. 4D, taken along the line F-F;

FIG. 4I is a front cross-sectional view of the slide valve bushing shown in FIG. 4D, taken along the line G-G;

FIG. 4J is a front cross-sectional view of the slide valve bushing shown in FIG. 4D, taken along the line H-H;

FIG. 5 is a top cross-sectional view of the ABDW control valve body shown in FIG. 1B;

FIG. 6 is a top cross-sectional view of the ABDW control valve body shown in FIG. 1D; and

FIG. 7 is a partial cross-sectional view of the ABDW control valve body shown in FIG. 1E.

### DETAILED DESCRIPTION

For purposes of the description hereinafter, the terms “upper”, “lower”, “right”, “left”, “vertical”, “horizontal”, “top”, “bottom”, “lateral”, “longitudinal”, and derivatives thereof shall relate to the inventive subject matter as oriented in the drawing figures. However, it is to be understood that the inventive subject matter may assume alternative variations and step sequences, except where expressly specified to the contrary. It is also to be understood that the specific devices and processes illustrated in the attached drawings, and described in the following specification, are simply example embodiments of the inventive subject matter. Hence, specific dimensions and other physical characteristics related to the embodiments disclosed herein are not to be considered as limiting.

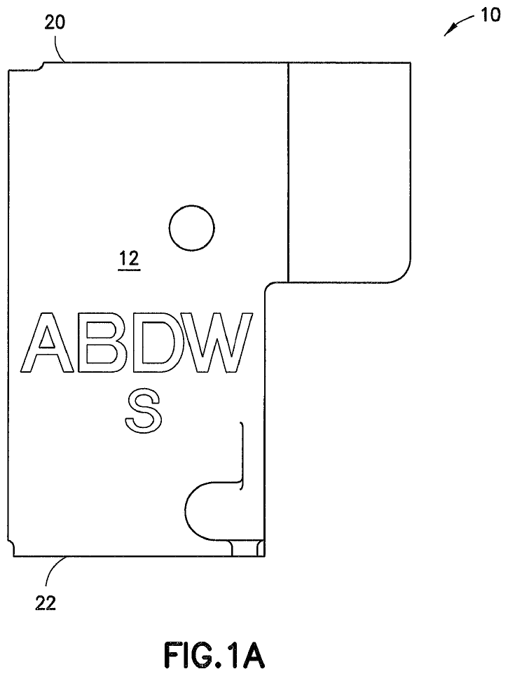

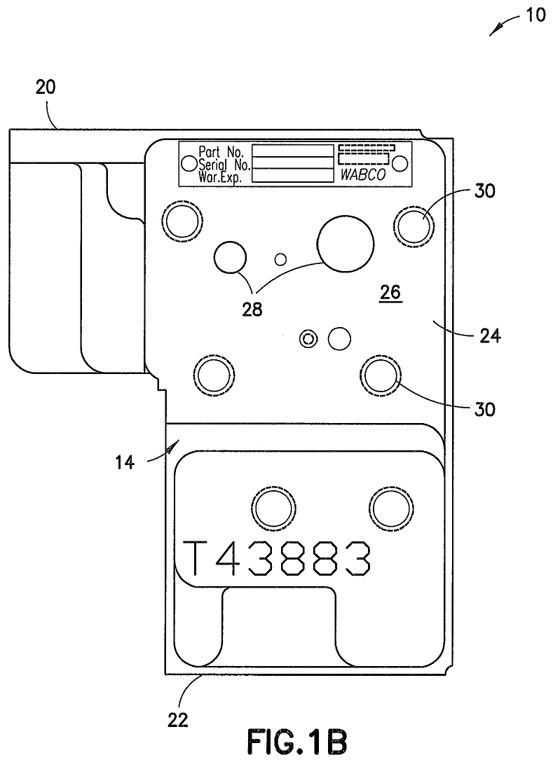

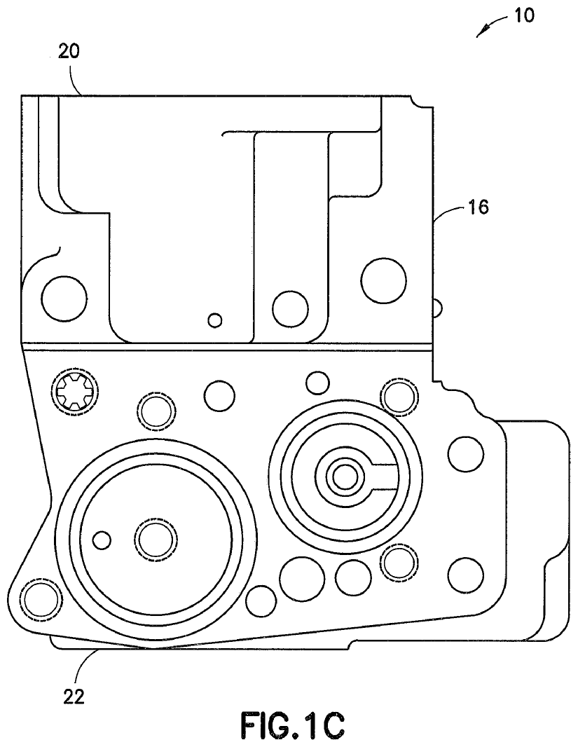

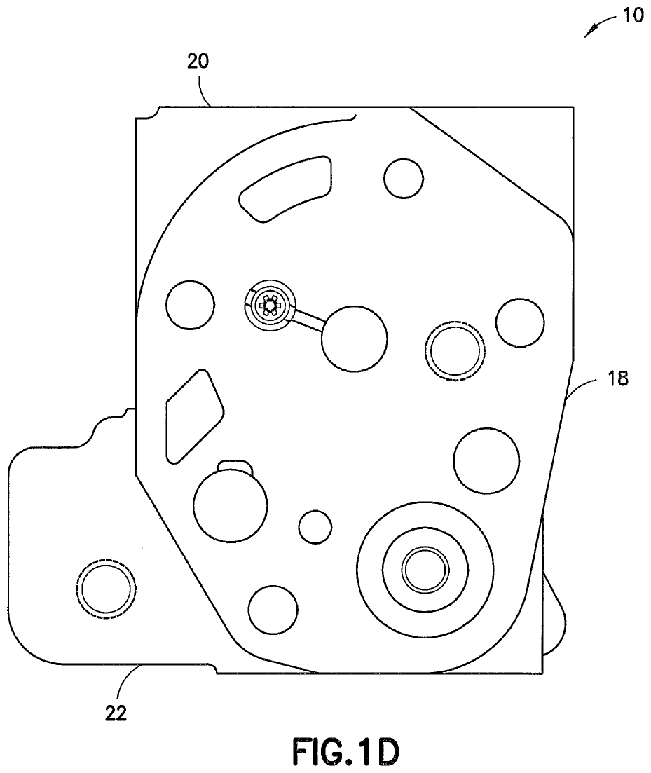

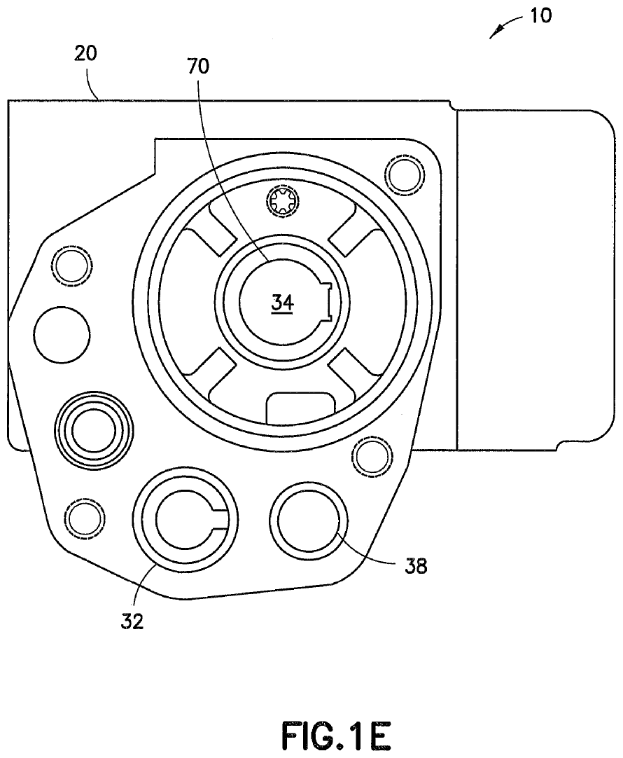

Referring to FIGS. 1A-1E, a body of a portion of a first control valve 10 is illustrated (hereinafter referred to as “valve body”). The portion that is shown may be an emergency portion or may be another portion of the valve. The control valve may be an ABDW valve in one embodiment. Valve body 10 is shown separate from the pipe bracket and service portion, which are omitted for the clarity of the disclosure. The valve body 10 can be coupled to conventional pipe bracket and service portion in a complete control valve assembly. Valve body 10 includes a front side 12 opposite a rear side 14. A pair of opposing sides 16, 18 extends between front side 12 and rear side 14 to define an external contour of valve body 10. A top side 20 and bottom side 22 extend across upper and lower portions of valve body 10.

As shown in FIG. 1B, rear side 14 of valve body 10 includes an interface 24 for connecting an accelerated application valve (not shown). Interface 24 includes a substantially planar face 26 having a plurality of first fluid passages 28 for directing fluid to and from the accelerated application valve. In one embodiment, the fluid is air and the fluid passages are air passages. Alternatively, another type of fluid (e.g., a liquid or another gas) can flow through the fluid passages. A plurality of fastener holes 30 is disposed around the plurality of fluid passages 28 for connecting the accelerated application valve to valve body 10. The fastener holes 30 are adapted for engagement with conventional fasteners (not shown) to removably secure the accelerated application valve to valve body 10.

Referring to FIG. 1E, a plurality of fluid connections 32 is provided on a top side 20 of valve body 10. A slide valve opening 34 is provided in a central portion of top side 20 and is adapted for engaging a slide valve (not shown). The slide valve engages the conforming seat in a slide valve bushing 70. The slide valve is housed within the slide valve opening and move axially with the emergency piston (not shown). As will be described hereafter, slide valve bushing 70 has a plurality of keyed passageways that can be positioned for fluid communication with a corresponding plurality of fluid passageways within valve body 10. Depending on the orientation of the slide valve within slide valve bushing 70, fluid pressure communication between various passageways within valve body 10 can be established or interrupted. Quick action passageway chamber 38 is provided adjacent to slide valve opening 34 on top side 20 of valve body 10.

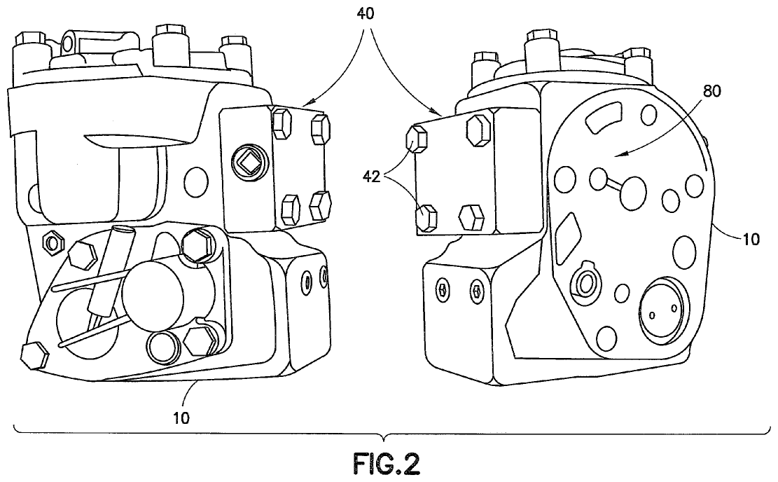

To convert a function of the first control valve (e.g., an ABDW valve) to that of a different, second control valve (e.g., an ABDX valve), several modifications and additions can be made to valve body 10. The second control valve may have an internal compensation for the stability volume provided by the accelerated application valve. The first valve body can be modified to include a corresponding stability volume in place of an accelerated application valve. Removal of the accelerated application valve from the first valve body can include the addition of a stability volume incorporating the quick action chamber breather choke. With reference to FIG. 2, an ABDW-type valve body 10 is shown with a breather assembly 40 provided to compensate for the removal of an accelerated application valve. A breather assembly 40 is connected to rear side 14 of valve body 10 by fastening the breather assembly 40 to planar face 26 using a plurality of fasteners 42 engaging bolt holes 30 (shown in FIG. 1B).

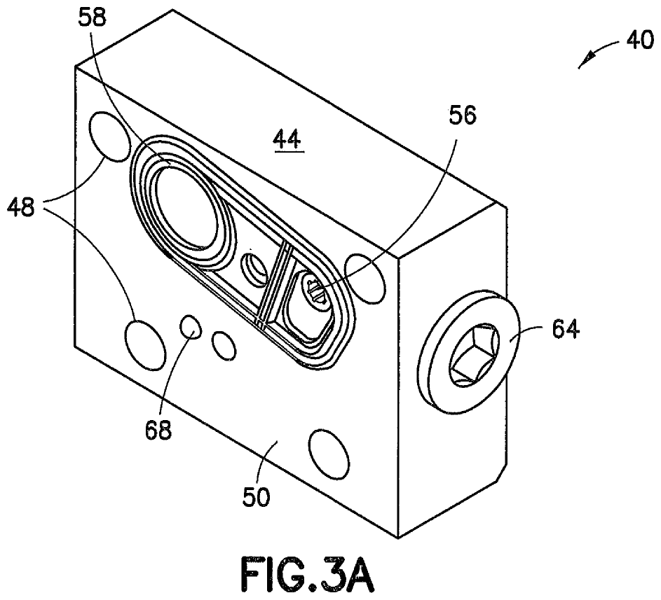

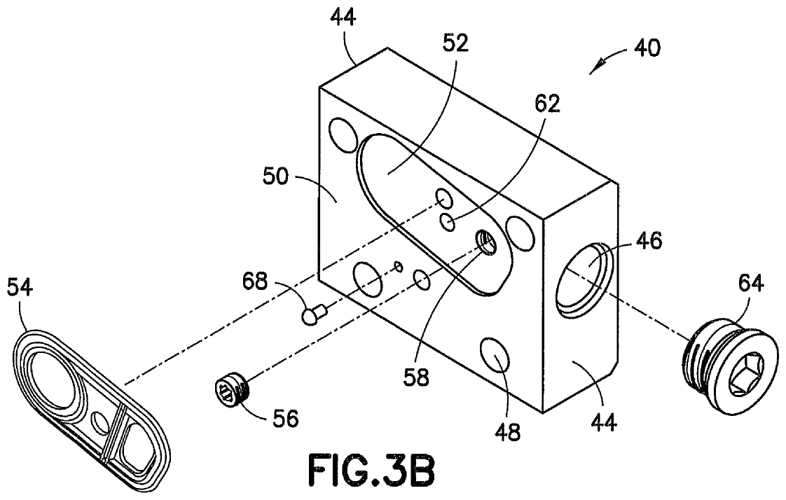

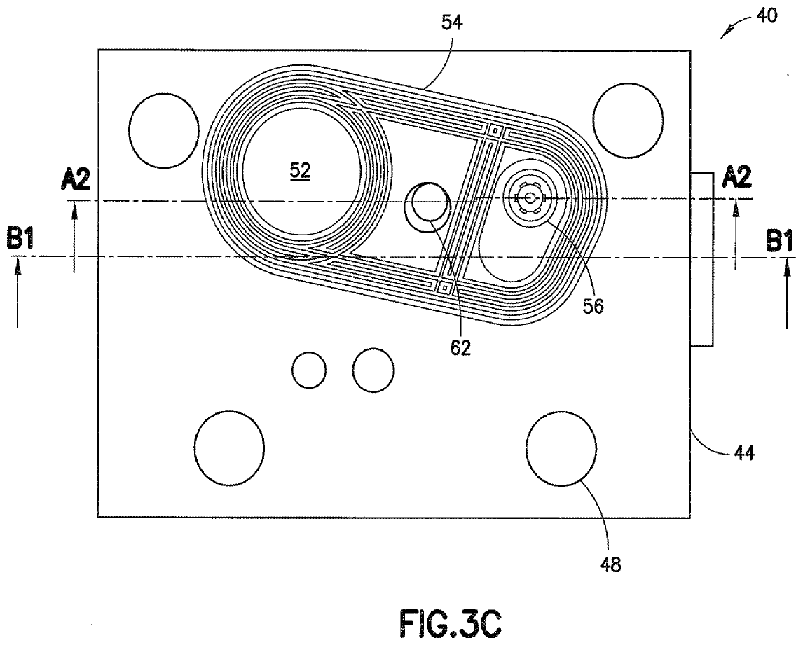

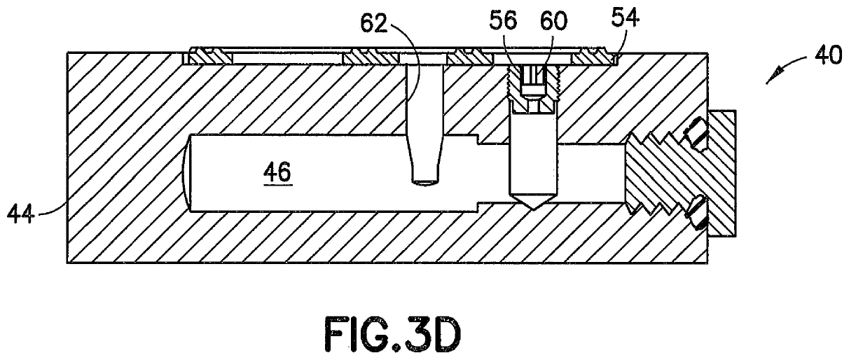

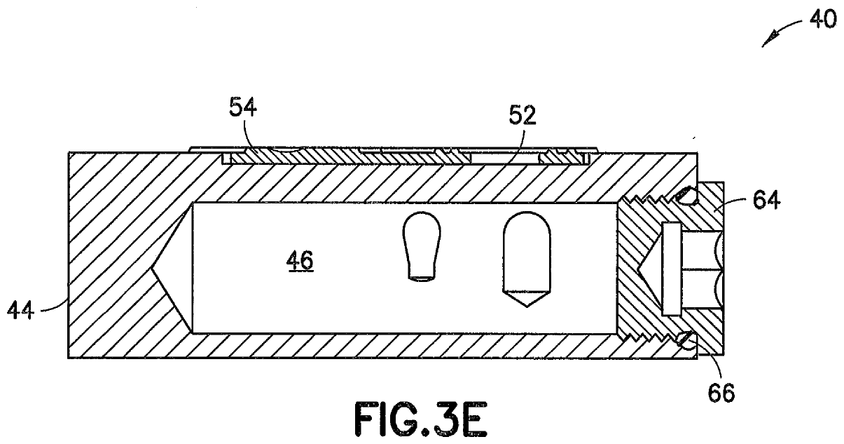

With reference to FIGS. 3A-3B, the breather body 40 can have a generally block-shaped body 44 with an internal volume 46. Alternatively, the breather assembly 40 can have another shape. Body 44 includes a plurality of through holes 48 corresponding to the plurality of fastener holes 30 on valve body 10 (shown in FIG. 1B). One or more (or all) of the through holes 48 can receive a fastener 42 (shown in FIG. 2) to fasten the breather assembly 40 to valve body 10. A first side 50 of body 44 includes a recessed face 52 adapted for retaining a gasket 54 therein. Gasket face 52 is dimensioned to encompass the plurality of first air passages 28 provided on rear side 14 of valve body 10 (see FIG. 1B). Gasket 54 provides a seal at the interface between first side 50 of breather assembly 40 and planar face 26 of valve body 10. Gasket 54 can be seated within gasket face 52.

With continuing reference to FIGS. 3A-3B, a choke plug 56 reduces the area of one of the plurality of first air passages 28. As shown in FIG. 3D, choke plug 56 may be threaded into a first opening 58 extending through the first side 50 of body 44. A central passage 60 extends through choke plug 56 to provide fluid communication between air passage 28 on valve body 10 and internal volume 46 of breather assembly 40. In one embodiment, central passage 60 is bored to have a diameter corresponding to a diameter of a #46 drill (0.081 in), but optionally can have another diameter. Choke plug 56 is in communication with the quick action chamber of valve body 10. A second opening 62 is provided adjacent to or near the first opening 58 and provides a direct fluid communication with the second air passage 28 on valve body 10.

With reference to FIGS. 3C-3E, and with continuing reference to FIGS. 3A-3B, internal volume 46 of breather assembly 40 extends within the interior of body 44. Because internal volume 46 can be closely controlled, a breather plate plug 64 may be provided on a side of body 44.

As shown in FIG. 3B, breather assembly 40 is provided with a keying feature 68 to prevent inappropriate interchange of an accelerated application valve with an otherwise unmodified ABDW-type emergency portion. As will be described in greater detail hereafter, several other modifications may be made to an existing ABDW-type emergency portion before breather plate is installed and the completed valve assembly is put into service. Drive stud 68 protrudes outward from first side 50 of body 44. The keying feature 68 can be received within a corresponding opening provided on a rear side 14 of valve body 10. Such opening is created in an existing ABDW-type emergency portion after the appropriate internal modifications have been made to the emergency portion to assure the proper functioning of breather assembly 40. In an event where an installation of a breather assembly 40 is attempted on an unmodified ABDW-type emergency portion, the keying feature 68 can prevent a proper mating between first side 50 of body 44 and planar face 26 of valve body 10. The arrangement of the keying feature 68 and the corresponding opening may be reversed such that the keying feature 68 is provided on the valve body 10 and a corresponding opening on the breather plate 44.

Breather assembly 40 can replace the accelerated application valve found on existing ABDW-type control valves and can serve to route the fluid from the quick action chamber port (i.e., one of the plurality of passages 28 provided on planar face 26) to internal volume 46. The fluid is then routed from internal volume 46 into the exhaust port (i.e. the other of the plurality of air passages 28 provided on planar face) on rear side of valve body 10 to which the accelerated application valve was previously mounted.

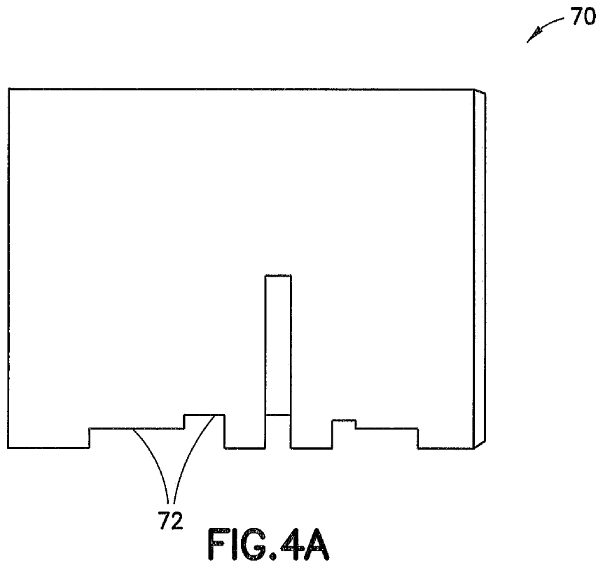

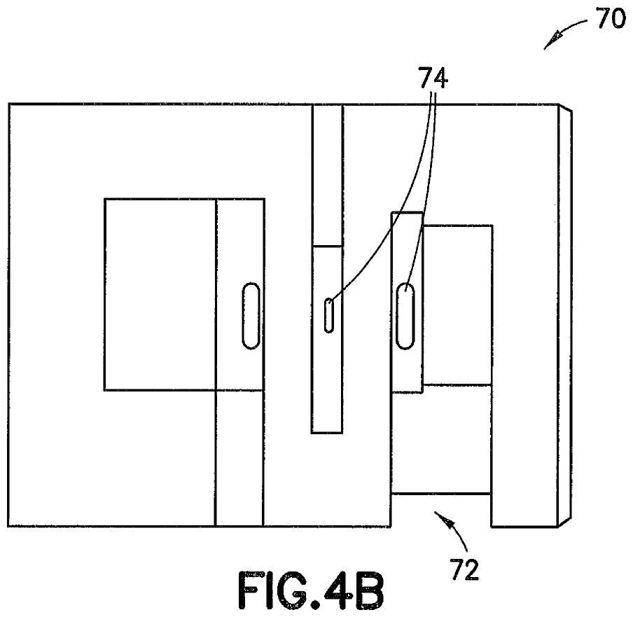

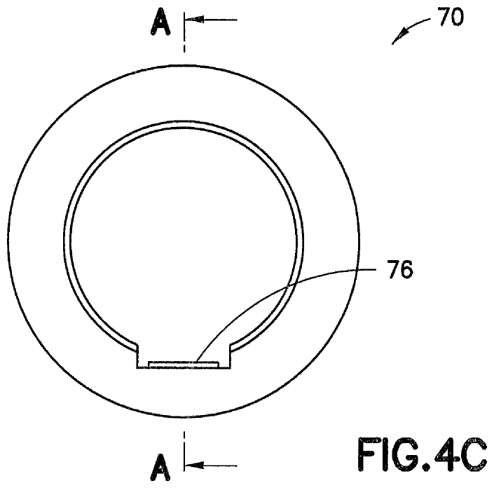

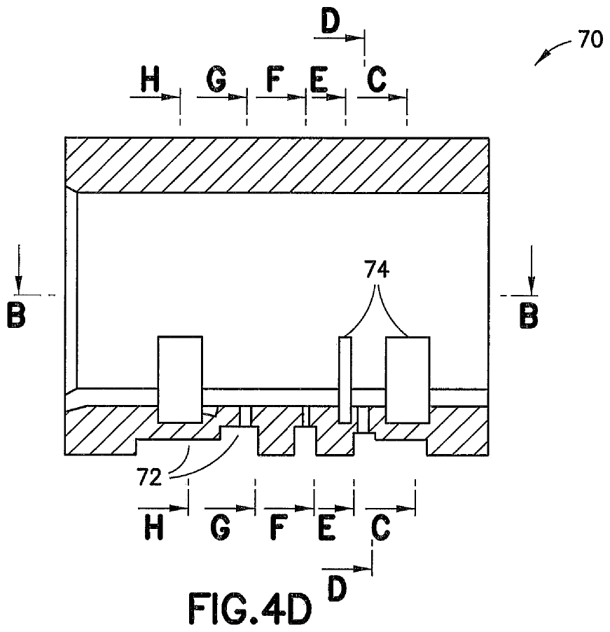

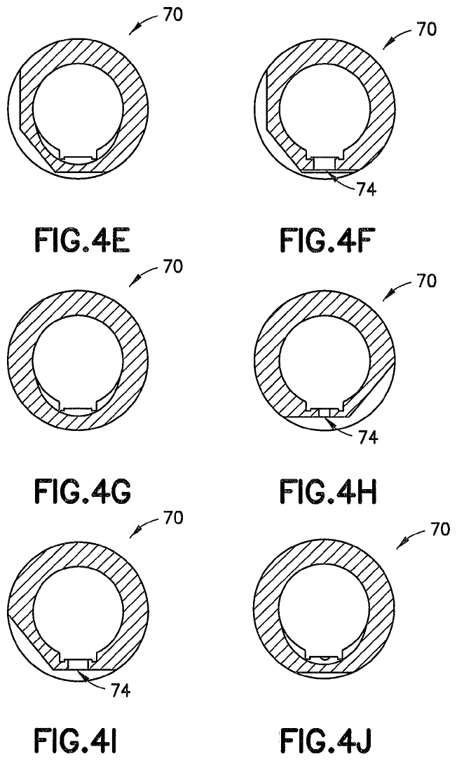

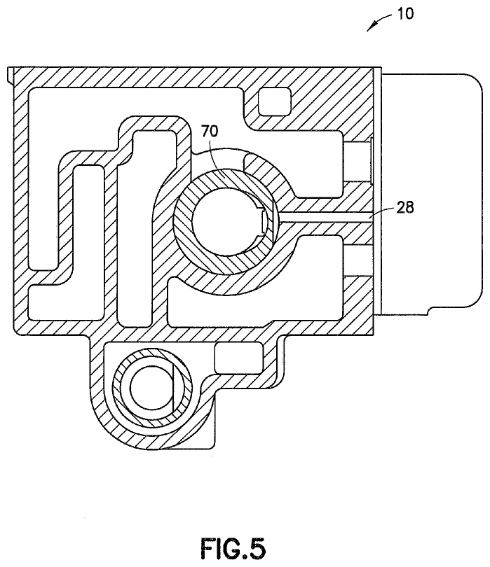

Due to differences between internal components of an ABDW-type control valve and an ABDX-type control valve, additional modifications can be made to an emergency portion of an existing ABDW-type valve body to convert the ABDW-type valve body to an ABDX-type body. The function of the accelerated application valve from an ABDW-type control valve is carried out internally within the valve body 10 modified in accordance with one embodiment of the present disclosure. To reduce or eliminate the need for an accelerated application valve, the activity carried out by accelerated application valve can be incorporated into the slide valve function. With reference to FIGS. 4A-4J, a slide valve bushing 70 replaces an existing ABDW-type bushing. Bushing 70 is installed in valve body 10 such that the slide valve seat faces the mounting face of the accelerated application valve. As illustrated in FIG. 4D, bushing 70 includes a plurality of recessed passages 72 extending around at least a part of the external perimeter of bushing 70. The plurality of recessed passageways 72 is separated axially along a longitudinal extent of the bushing 70. Plurality of recessed passages 72 is adapted for providing fluid communication between various air passageways within valve body 10. Depending on the orientation of the slide valve, the plurality of recessed passageways 72 of bushing 70 route the air to the appropriate air passageway. Additionally, as further illustrated in FIG. 4D, bushing 70 includes a plurality of through passages 74 extending radially through at least one side of bushing 70. The plurality of through passages 74 is separated axially along a longitudinal extent of the bushing 70. Several slots 76 are provided along the longitudinal length of bushing 70 for providing fluid communication with the vent valve, the brake pipe, and the exhaust valve. FIG. 5 shows bushing 70 inserted into slide valve opening 34 on top side 20 of valve body 10.

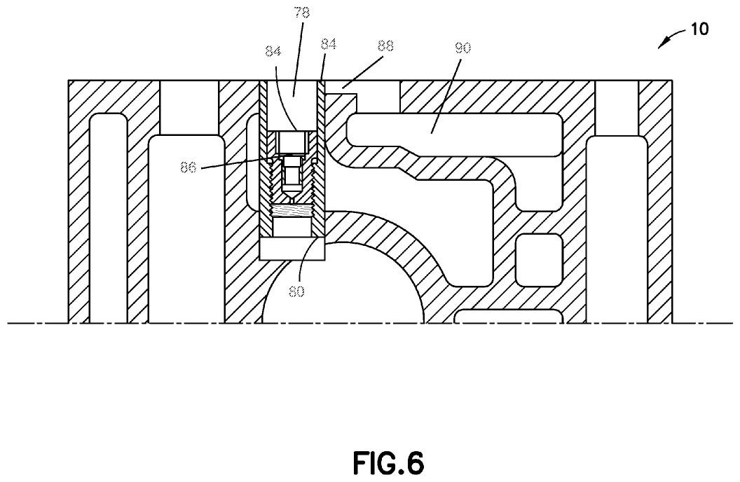

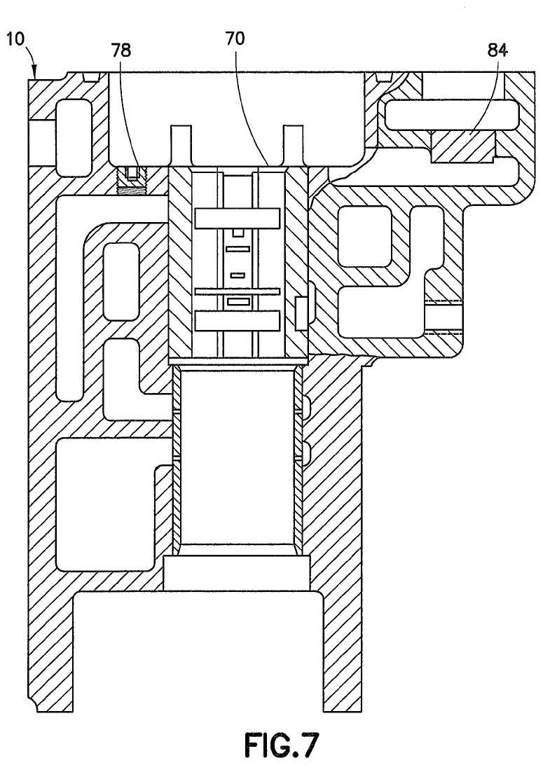

With reference to FIGS. 1D and 6, several modifications are made to an existing accelerated application valve (AAV) opening 78 on valve body 10. A tapered hole 80 is drilled or otherwise created in AAV opening 78 to accept AAV bushing 82. As shown in FIG. 1D, AAV bushing 82 is pressed into tapered hole 80. An AAV choke plug 84 is provided inside AAV bushing 82. AAV choke plug 84 has a central through passage having a reduced diameter compared to a diameter of AAV opening 78. A mesh filter 86 is provided on AAV choke plug 84 to filter impurities in the air passing through AAV choke plug 84. With continuing reference to FIG. 1D, a slot 88 is milled between AAV opening 78 and an air chamber 90. Slot 88 establishes a fluid communication between AAV opening 78 and air chamber 90. With reference to FIGS. 1E and 7, a plurality of plugs 92 is provided to seal two of the plurality of air connections 32 provided on top side of valve body 10. The plugs 92 may be threaded to the valve body 10, press fit to the valve body 10, or certain plugs 92 may be threaded to the valve body 10 while other plugs 92 are press fit to the valve body 10.

By replacing the accelerated application valve on an ABDW-type control valve, and by modifying the internal components of the ABDW-type control valve in accordance with the teachings described above, an ABDW-type control valve can be modified to have the function of a ABDX-type control valve. This can eliminate or reduce the need to scrap an existing ABDW-type control valve body when updating the braking system of a railway vehicle to utilize the ABDX-type equipment. Performance characteristics of an ABDX-type control valve are achieved by modifying an existing ABDW-type valve body and replacing the necessary components in accordance with the embodiments described herein.

While various embodiments of the apparatus and method for ABDW to ABDX control valve conversion were provided in the foregoing description, those skilled in the art may make modifications and alterations to these embodiments without departing from the scope and spirit of the inventive subject matter. For example, it is to be understood that this disclosure contemplates that, to the extent possible, one or more features of any embodiment can be combined with one or more features of any other embodiment. Accordingly, the foregoing description is intended to be illustrative rather than restrictive. The inventive subject matter described hereinabove is defined by the appended claims and all changes to the inventive subject matter that fall within the meaning and the range of equivalency of the claims are to be embraced within their scope.

What is claimed is:

1. A system comprising:
a control valve body configured to be in communication with a fluid supply system of a vehicle braking mechanism, the control valve body configured to control application and release of one or more vehicle brakes;
a breather assembly coupled with the control valve body, the breather assembly having an internal stability volume for preventing misapplication of the one or more vehicle brakes due to fluctuations in fluid of the vehicle braking system;
a slide valve bushing provided inside the control valve body, the slide valve bushing configured to establish fluid communication with at least a first passageway within the control valve body; and
a first plug for sealing a second passageway within the control valve body.

2. The system according to claim 1, wherein the breather assembly further comprises:
a breather body having a first side and an opposite second side, the breather body also including an internal stability volume between the first side and the second side; and
a first opening and a second opening in communication with the internal stability volume and in alignment with a first passageway and a second passageway on the first control valve body.

3. The system according to claim 2, wherein the breather assembly further comprises a breather plate plug connected to the breather body and in communication with the internal stability volume.

4. The system according to claim 2, wherein the breather assembly further comprises a recess on the first side of the breather body that is configured to receive a gasket.

5. The system according to claim 2, wherein the breather assembly further comprises a choke plug in at least one of the first opening or the second opening, the choke plug having a central passage extending therethrough.

6. The system according to claim 2, wherein the breather assembly further comprises a keying feature configured to engage a corresponding opening in the control valve body.

7. The system according to claim 1, wherein the slide valve bushing further comprises recessed passageways extending around at least a part of an external perimeter of the slide valve bushing.

8. The system according to claim 1, wherein the slide valve bushing further comprises through passages extending radially through at least one side of the slide valve bushing.

9. The system according to claim 1, wherein the first plug is choke plug provided in an accelerated application valve opening on the control valve body.

10. The system according to claim 9, wherein the choke plug includes a mesh filter.

11. The system according to claim 9, wherein a slot is provided in the control valve body between accelerated application valve opening and an air chamber.

12. A control valve breather assembly comprising:
a body having opposite first and second sides and an internal volume between the first and second sides; and
first and second openings in communication with the internal volume and positioned to align with first and second passageways on a valve interface of a control valve body
wherein the body is configured to convert the control valve body to a different model of control valve by mounting the body to the valve interface of the control valve body.

13. The breather assembly of claim 12, further comprising a plug connected to the body and in communication with the internal volume.

14. The breather assembly of claim 12, further comprising a recess on the first side of the body that is configured to receive a gasket.

15. The breather assembly of claim 12, further comprising a choke plug in one of the first opening or the second opening.

16. The breather assembly of claim 12, wherein the choke plug includes a central passage extending therethrough.

17. The breather assembly of claim 12, further comprising a keying feature protruding from the first side of the body, the keying feature configured to engage a corresponding opening provided on the control valve body.

18. A method for converting a control valve to a different model of control valve, the method comprising:
removing an accelerated application valve from the control valve to expose an accelerated application valve interface of the control valve;
connecting a breather assembly on the accelerated application valve interface, the breather assembly having an internal volume for compensating a function of the accelerated application valve;
connecting a slide valve bushing inside the control valve for establishing fluid communication with at least one passageway within the control valve; and
connecting at least one plug for sealing at least one air passageway within the control valve.

19. The method according to claim 18, further comprising:
expanding an accelerated application valve opening; and
providing a slot between the accelerated application valve opening and an air chamber on the control valve for establishing a fluid communication between the accelerated application valve opening and the air chamber.

20. The method according to claim 18, wherein the breather assembly further comprises:
a body having a first side opposite a second side and the internal volume between the first side and the second side; and
a first opening and a second opening in communication with the internal volume and in alignment with a first passageway and a second passageway on the accelerated application valve interface of the control valve.
